(19) United States
(12) Patent Application Publication
(10) Pub. No.: US 2025/0256929 A1
(43) Pub. Date: Aug. 14, 2025

(54) System and Method for Loading and Unloading Tanks Used in a Physical, Chemical and/or Biological Process

(71) Applicant: DYNAMIC AIR LTDA, Sao Paulo (BR)

(72) Inventors: Horacio N. Paez, Sao Paulo (BR); Gregory J. Steele, Saint Paul, MN (US)

(73) Assignee: DYNAMIC AIR LTDA, Sao Paulo (BR)

(21) Appl. No.: 19/048,405

(22) Filed: Feb. 7, 2025

(30) Foreign Application Priority Data
Feb. 9, 2024 (BR) 1020240027086

(51) Int. Cl. B65G 53/50; B65G 53/36; B65G 53/66

(52) U.S. Cl. CPC B65G 53/50; B65G 53/36; B65G 53/66

(57) ABSTRACT

The present invention relates to a system for loading and unloading agents in the form of particulate solid material, used for carrying out a physical, chemical, and/or biological process in one or more tanks. The system includes: an intermediate tank, a pump, and a pneumatic conveyor. The intermediate tank and the pump are fluidically connected. For unloading a tank containing saturated or degraded solid material particles, an empty or partially empty solid material tank is fluidically connected to the intermediate tank and the tank containing saturated or degraded solid material particles. For loading a tank, a solid material tank containing unsaturated or undegraded solid material particles is fluidically connected to the intermediate tank.

### TECHNICAL FIELD

The present invention relates to the loading and unloading of tanks. More particularly, the present invention relates to a pneumatic system and method for loading and unloading solid material used to carry out a physical, chemical or biological process in a tank.

### BACKGROUND OF THE ART

Tanks are commonly used for the storage and transport of various products. Tanks, typically made of metal or composite materials, can also be used as containers within which a physical, chemical, or biological process takes place. To carry out and control such processes, agents of different natures can be employed, such as chemical agents, catalysts, and adsorbents. For example, when a chemical or biological reaction must occur, a tank acts as a reactor, and some type of catalyst is used inside it.

Reactors are important equipment for carrying out and controlling chemical and/or biological reactions on an industrial or laboratory scale. Reactors are designed to provide optimal conditions for chemical substances to react and form desired products. They play a crucial role in various sectors such as the chemical, pharmaceutical, food, and materials industries. There are several types of reactors, each suitable for different types of processes. Some of the most common reactors include batch reactors, continuous reactors, stirred tank reactors, tubular reactors, and fixed-bed reactors. The choice of reactor type depends on the characteristics of the reaction, the required conditions, and the objectives of the process. For example, the use of reactors in the oil industry is well-known, such as reactors used to transform heavy hydrocarbons into light ones using catalysts in so-called catalytic reactors.

The loading and unloading of catalysts in reactors depend on the type of reactor and the specific process. For fixed-bed reactors, catalysts are typically loaded at the start, during reactor installation. This involves filling the reactor bed with catalyst particles suitable for the desired reaction. In stirred tank reactors, for instance, the catalyst can be added directly to the tank or placed in a suspension system. In contrast, in tubular systems, the catalyst can be placed in a specific section of the tube where the reactants flow. Unloading in fixed-bed reactors usually occurs during scheduled maintenance shutdowns. Spent or saturated catalyst can be removed from the bed and replaced with a new catalyst. In stirred tank reactors, the catalyst can be removed using methods such as filtration or sedimentation, depending on the nature of the catalyst. Cleaning and replacing catalysts in tubular systems can be carried out by stopping the flow and replacing the catalyst in the appropriate section.

Alternatively, or additionally to functioning as a reactor, a tank may also contain an agent that serves a filtration role. In this case, the agent acts as an adsorbent, trapping the material to be filtered on its surface. Some agents can simultaneously function as both catalyst and adsorbent.

With use, after a certain number of chemical or biological reactions and/or physical separations of particles have been carried out, the agent begins to lose its efficiency, either due to saturation, chemical degradation, or loss of permeability, requiring its replacement.

In all cases, the loading of new agents and the unloading of spent agents represent a technical challenge and often require: complex mechanical equipment and operations at the top of the tanks, which can pose risks to people and facilities around; and/or exhaustive manual labor with human intervention inside the tank, which, besides being slow and inefficient, involves working in confined spaces with contaminated and hazardous atmospheres.

### SUMMARY OF THE INVENTION

The present invention relates to a system for loading and unloading agents in the form of particulate solid material used for carrying out a physical, chemical, and/or biological process in one or more tanks. The system comprises: an intermediate tank; a pump; and a pneumatic conveyor. The intermediate tank and the pump are fluidically connected. For unloading a tank containing saturated or degraded solid material particles, an empty or partially empty solid material tank is fluidically connected to the intermediate tank and to the tank containing saturated or degraded solid material particles. The pump is configured to generate negative pressure in the intermediate tank, the empty or partially empty solid material tank, and the tank containing saturated or degraded solid material particles to carry the saturated or degraded solid material particles from inside the tank to the inside of the empty or partially empty solid material tank. For loading a tank, a solid material tank containing unsaturated or undegraded solid material particles is fluidically connected to the intermediate tank. The pump is configured to generate negative pressure in the intermediate tank and in the solid material tank containing unsaturated or undegraded solid material particles to carry the unsaturated or undegraded solid material particles from inside the solid material tank to the inside of the intermediate tank. The pneumatic conveyor is positioned below the intermediate tank, and the intermediate tank is configured to carry the unsaturated or undegraded solid material particles received into the pneumatic conveyor. The pneumatic conveyor is fluidically connected to the tank to carry the unsaturated or undegraded solid material particles received into the tank.

Optionally, the one or more tanks are reactors.

Optionally, the solid material is: a catalyst; an adsorbent; or both a catalyst and an adsorbent.

Optionally, the one or more tanks, the solid material tank, the intermediate tank, and the pump are fluidically connected by means of transport lines, and the one or more tanks and the pneumatic conveyor are fluidically connected by means of a transport line.

Optionally, the transport lines are: rigid; flexible; or comprise both rigid and flexible parts.

Optionally, the solid material tank has a conical bottom section and an outlet at the bottom.

Optionally, the intermediate tank has a conical bottom section and an outlet at the bottom.

Optionally, the intermediate tank comprises a filtration means inside it to filter the flow of material coming from the solid material tank.

Optionally, the solid material tank comprises a level sensor or a weight sensor.

Optionally, the intermediate tank comprises a level sensor or a weight sensor.

Optionally, the system comprises a connection box to connect the transport line that connects a tank to a solid material tank.

Optionally, the system comprises a receiving box at one end of the transport line that connects the pneumatic conveyor to a tank to direct unsaturated or undegraded solid material particles into the tank.

The present invention also relates to the use of the system as described above for the loading and unloading of one or more tanks.

The present invention is further related to a method for loading and unloading solid material particles used for carrying out a physical, chemical, and/or biological process in one or more tanks through a system as described above. The method comprises the steps of, for unloading a tank containing saturated or degraded solid material particles: generating a negative pressure in the intermediate tank, the empty or partially empty solid material tank, and in the tank containing saturated or degraded solid material particles to move the saturated or degraded solid material particles from inside the tank to the empty or partially empty solid material tank; and, for loading a tank: generating a negative pressure in the intermediate tank and in the solid material tank containing unsaturated or undegraded solid material particles to move the unsaturated or undegraded solid material particles from inside the solid material tank into the intermediate tank; moving the unsaturated or undegraded solid material particles from the intermediate tank into the pneumatic conveyor; and moving the unsaturated or undegraded solid material particles from the pneumatic conveyor into the tank.

### BRIEF DESCRIPTION OF THE DRAWINGS

FIG. 1 illustrates an embodiment of the system according to the present invention during the unloading of a tank.

FIG. 2 illustrates an embodiment of the system according to the present invention during the loading of a tank.

FIG. 3 illustrates an example of an embodiment of the system according to the present invention on an offshore platform.

FIG. 4 illustrates a perspective view of a part of the example of embodiment shown in FIG. 3.

### DETAILED DESCRIPTION

The following description refers to transport lines connecting the different components of the system of the present invention. As a person skilled in the art will recognize, the connected components of the system described below must be fluidically connected. However, different configurations for achieving fluidic connections are possible, such as, for example, the use of multiple lines between two components and manifolds.

Similarly, the description refers to saturated or degraded material particles and unsaturated or undegraded material particles. It should be understood that saturated or degraded material particles include particles that are at least partially saturated or degraded. For the purposes of the present invention, the material particles do not need to be completely saturated or degraded to be considered as saturated or degraded material particles. The present invention deals with unloading particles from a tank that need to be replaced and with the loading new particles.

### 1—Tank Unloading

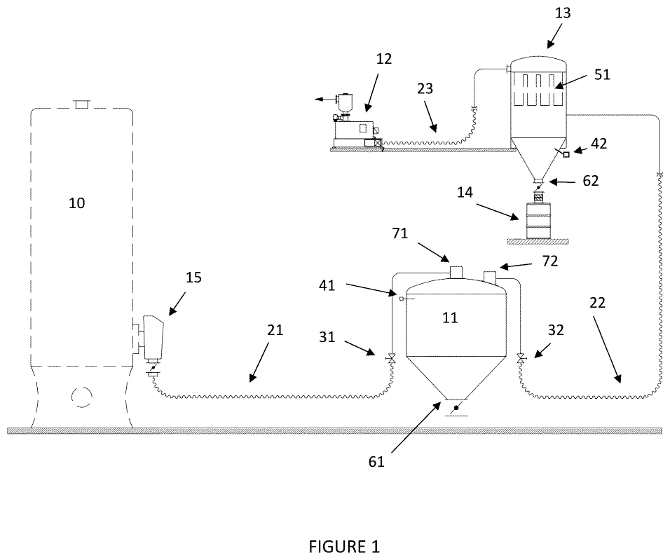

FIG. 1 illustrates an example of a system according to the present invention during the unloading of a tank 10. The system comprises a solid material tank 11, an intermediate tank 13 and a pump 12. A transport line 23 connects the pump 12 to the intermediate tank 13. A transport line 22 connects the intermediate tank 13 to the solid material tank 11. A transport line 21 connects the solid material tank 11 to the tank 10.

Physical, chemical, and/or biological reactions occurring inside the tank 10 cause the solid material inside the tank to become saturated or degraded over time. At this point, the solid material particles inside the tank 10 need to be removed. The concept of dense-phase vacuum pneumatic conveying, known in the prior art, is employed. The pump 12 is activated to suction through line 23. At some point, negative pressure is generated in line 23, in the intermediate tank 13, in line 22, in the solid material tank 11, in line 21, and finally in tank 10. The tank 10 can, for example, be opened at its top to allow air to flow into the system, facilitating the movement of the solid material particles through the system. Alternatively, air or any other gas such as N2, argon, or carbon dioxide can be introduced into the tank 10 to enable the flow of the solid material particles. The generated negative pressure will reach a level where the solid material particles inside the tank 10 will begin to move into and through line 21 to the solid material tank 11. Since line 22 is connected to the top of the solid material tank 11, the solid material particles will accumulate, due to centrifugal and gravitational forces and due to the reduction in speed below pneumatic drag values, at the bottom of the tank 11.

The tank 10 may be a reactor connected to a chemical and/or biological process, and the solid material may be any catalyst capable of performing such a chemical and/or biological process. The tank 10 may also be related to a physical filtration process, and the solid material may be any adsorbent capable of performing such a filtration process. In some cases, the solid material may serve both as a catalyst and an adsorbent.

As one skilled in the art will recognize, any vacuum pump or compressor equipment known and commercially available can be used as the pump 12. The size and power of the pump 12 will depend on each project, such as the type of tank used, the tank dimensions, the type and length of the transport lines, and the type of connections employed. It is also possible to install more than one pump 12, which can alternate or work together to generate a negative pressure in the system of the invention.

The transport lines 23, 22 and 21 can be rigid, such as metal pipes, or flexible, such as rubber hoses. The choice of rigid or flexible lines, or a combination of both, will also depend on each project and the site of installation of the system of the present invention.

The solid material tank 11 is preferably a metallic tank that will accumulate the solid material particles removed from the tank 10. The solid material tank 11 has an inlet 71 and an outlet 72 at its top. The inlet 71 is connected to transport line 21, and the outlet 72 is connected to transport line 22. Preferably, it has a conical bottom section to facilitate the subsequent unloading of the accumulated solid material particles through a lower outlet 61.

In a preferred embodiment of the system of the invention, the intermediate tank 13 may comprise, inside it, a filtration means 51 to filter the material arriving through line 22. Thus, solid material particles, especially finer or powdered particles, as well as any other particle present in the tank 10, the solid material tank 11, or in the transport lines 21, 22, that may escape through the solid material tank 11 during suction by the pump 12, are filtered by the filtration means 51 before exiting the intermediate tank 13 through transport line 23. This prevents such particles from reaching the pump 12, which could cause potential damage to the pump 12, and also prevents such particles from being released into the environment by the pump 12, which could be harmful to the environment or any living being near the outlet of pump 12.

The filtration mean 51 can be any known and commercially available filter, such as one or more fabric or plastic meshes or a set of one or more microporous papers. Alternatively, or additionally, other filtration means (not shown) may also be positioned along the system, such as at the inlet of pump 12, at the outlet of tank 11 and at transport line 22.

As with the solid material tank 11, residual particles that reach the intermediate tank 13 and are filtered by the filtration means 51 will accumulate by gravity at the bottom of the intermediate tank 13.

The intermediate tank 13 is preferably metallic. Also preferably, it has a conical bottom section to facilitate the subsequent discharge of accumulated particles through a lower outlet 62.

At some point during the unloading of tank 10, the solid material tank 11 will fill up. At this point, the pump 12 is turned off, and valves 31, 32 positioned along lines 21, 22 are closed, allowing the loaded tank 11 to be disconnected and a new empty tank 11 to be connected. Optionally, the solid material tank 11 and valves 31, 32 are designed to maintain an inert atmosphere inside the loaded solid material tank 11 after its disconnection from the system.

With the new solid material tank 11 installed in the system, valves 31, 32 are reopened, and pump 12 is turned back on, continuing or starting the unloading process of tank 10 or a new tank 10. Depending on the project, the volume of solid material to be unloaded from tank 10 may correspond to the volume of the solid material tank 11. As any person skilled in the art will note, although an empty solid material tank 11 has been described for unloading tank 10, the solid material tank 11 can be partially empty and still capable of receiving saturated solid material particles.

Since pump 12 can be a large, high-power device with a labor-intensive start/stop process, instead of turning off pump 12 during the disconnection of the loaded tank 11 from the system, a relief valve (not shown), positioned either on pump 12 or transport line 23, can be opened. This allows the suction created by pump 12 to draw from the environment instead of the system. After a new empty tank 11 is connected to the system and valves 31, 32 are opened, the relief valve can be closed, restoring suction to the system.

Valves 31, 32, as well as any other valves used throughout the system, can be any known and commercially available valves, such as a ball valve.

The state of filling of solid material tank 11 can be manually verified. Alternatively, a weight sensor (not shown), such as a scale, can be placed beneath the solid material tank 11 to detect when its fill level reaches a maximum limit. Alternatively, a level sensor 41 can be used inside the solid material tank 11 to determine when the fill level reaches a maximum limit.

Eventually, the intermediate tank 13, especially when the filtration means 51 is present, will also fill up. Its maximum fill level can be checked in the same way as with the solid material tank 11, i.e., manually, or using, for example, a weight sensor or a level sensor 42.

The level sensor 41, 42 can be any known and commercially available one, such as, for example, a hydrostatic level sensor, a capacitive level sensor or an ultrasonic level sensor.

The system may optionally include a container 14 which may be positioned below the intermediate tank 13 to collect the particles accumulated inside the intermediate tank 13. For example, when the intermediate tank 13 reaches a maximum fill level, a valve positioned below the lower outlet 62 can be opened, allowing the particles to flow into the container 14.

The container 14 can be any container capable of receiving and storing the particles, such as a metallic drum.

The system may optionally include a connection box 15 attached to the outlet of tank 10, preferably at its lower section. The connection box 15 may optionally take the form of a discharge funnel. The connection box 15 can be a metallic box primarily serving as an interface between the outlet of tank 10 and the type of connection of transport line 21, acting as a quick-connect/disconnect mechanism between the system and tank 10. This is particularly useful for unloading multiple tanks 10. The connection box 15 may also be equipped with a valve to open or close its outlet, connecting or disconnecting the outlet of tank 10 to the system.

Thus, the system of the present invention enables the unloading of one or more tanks 10 in a simple and efficient manner, where only the solid material tanks 11 are connected and disconnected from the system. In a “plug-and-play” fashion, an empty solid material tank 11 is connected to the system for unloading one or more tanks 10. There is no need to move any elements of the system. As a solid material tank 11 fills with solid material particles, it is only necessary to operate the valves and adjust the transport lines to disconnect tank 11 and connect another empty solid material tank 11 to the system.

### 2—Tank Loading

Once unloaded, tank 10 is ready to receive new solid material that is not saturated or degraded. Depending on the industry, tank 10 may first undergo a special cleaning and inerting process, which is not within the scope of the present invention. According to the invention, the same system structure used for unloading tank 10 is also used for loading tank 10.

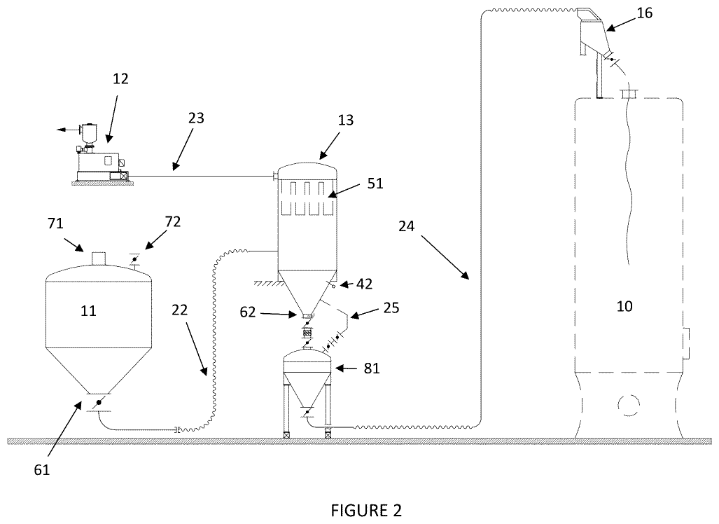

FIG. 2 illustrates an example of the system according to the present invention during the loading of tank 10. The solid material tank 11 is filled with new solid material (not saturated or degraded). Inlet 71 is opened to allow the flow of atmospheric air to promote the movement of the material out of the solid material tank 11. Outlet 72 is closed, and lower outlet 61 is opened.

As in the unloading of tank 10, the pump 12 is activated to generate a negative pressure in transport line 23, in the intermediate tank 13, and in transport line 22, which is now connected to the lower outlet 61 of the solid material tank 11. The generated negative pressure will reach a level where the solid material particles inside the solid material tank 11 will start to move into and along transport line 22 until they reach the intermediate tank 13. Due to gravity, the solid material particles will accumulate at the bottom of the intermediate tank 13.

If the filtration mean 51 is present, as it is optionally the case during the unloading of tank 10 already explained with reference to FIG. 1, the filtration means 51 will filter any solid material particles attempting to exit the intermediate tank 13 toward the pump 12.

The main function of the intermediate tank 13, in tank 10 loading procedure, is to receive the solid material particles from the solid material tank 11 and direct them through the lower outlet 62 into a pneumatic conveyor 81 positioned below the intermediate tank 13. During the discharge of solid material particles from the intermediate tank 13 into the pneumatic conveyor 81, the pump 12 is turned off, or the relief valve is opened, as in the unloading of tank 10 explained in relation to FIG. 1. The lower outlet 62 is opened, and the material inlet of the pneumatic conveyor 81 is also opened.

The same level sensor 42 described in relation to FIG. 1 can optionally be used to determine when to stop loading the intermediate tank 13 and begin discharging the solid material particles from the intermediate tank 13 into the pneumatic conveyor 81.

The principles of pneumatic conveying are widely known in the art. Furthermore, any skilled person in the art can employ a range of commercially available pneumatic conveyors. For example, the HDP4000 pneumatic conveyors manufactured and sold by Dynamic Air Ltda, which utilize the concept of dense-phase pressure pneumatic conveying, can be used.

Once the pneumatic conveyor 81 is loaded with solid material particles, its material inlet is closed, its lower material outlet is opened, and its transport fluid inlet is opened. This fluid is preferably air but may also be gases such as N2, argon, or carbon dioxide. Then, the air is injected, causing the solid material particles to exit the pneumatic conveyor 81, travel along transport line 24, and reach tank 10.

In an optional embodiment of the present invention, a second pump is provided to supply air to the pneumatic conveyor 81. In another preferred embodiment, the pump 12 itself is used to supply air to the pneumatic conveyor 81. As any skilled person in the art will note, it is sufficient to release the inlet of pump 12 and connect a pneumatic line to the outlet of pump 12 to provide a positive pressure. In an even more preferred embodiment, there is no need to install a pneumatic line between pump 12 and the pneumatic conveyor 81. Transport line 23 can be connected to the outlet of pump 12, which will direct air into the intermediate tank 13. In this case, a pneumatic line 25 is installed between the intermediate tank 13 and the pneumatic conveyor 81. All the inlets and outlets of the intermediate tank 13 are closed except for the outlet to pneumatic line 25, allowing air from pump 12 to be injected into the pneumatic conveyor 81.

Like transport lines 23, 22 and 21, transport line 24 and pneumatic line 25 can be rigid, such as metallic pipes, or flexible, such as rubber hoses. The choice between rigid or flexible lines, or a combination of both, will also depend on each project and the site of installation the system of the present invention.

In an optional embodiment, transport line 24 is directly connected to tank 10, preferably at its upper section. In another optional embodiment, transport line 24 is connected to a receiving box 16 that directs the solid material particles into tank 10. Like the connection box 15, the receiving box 16 serves as an interface between the tank inlet and the type of connection of transport line 24, acting as a receiving hopper and a quick-connect/disconnect mechanism between tank 10 and the system, which is particularly useful for loading multiple tanks 10. The receiving box 16 may also be equipped with a valve to open or close its outlet, connecting or disconnecting the inlet of tank 10 to/from the system.

The cycle of loading/unloading the intermediate tank 13 and loading/unloading the pneumatic conveyor 81 can be repeated as many times as necessary to transfer the new solid material from the solid material tank 11 to tank 10. When the solid material tank 11 is empty, its lower outlet 61 can simply be closed to disconnect it from the system and reconnect transport line 22 to the lower outlet 61 of another filled solid material tank 11.

Thus, the system of the present invention enables the loading of one or more tanks 10 in a simple and efficient manner, where only the solid material tanks 11 are connected and disconnected from the system. In a “plug-and-play” manner, a solid material tank 11 loaded with new solid material is connected to the system for loading one or more tanks 10. As the solid material tank 11 empties its solid material particles, it is disconnected and replaced with another filled solid material tank 11. Additionally, as can be readily noted, the same system used to unload tank 10 is also used to load tank 10. Thus, in addition to providing simple and efficient loading and unloading of tanks, the system of the present invention is easy to install and can be continuously used for both loading and unloading tanks.

### 3—Example of Embodiment

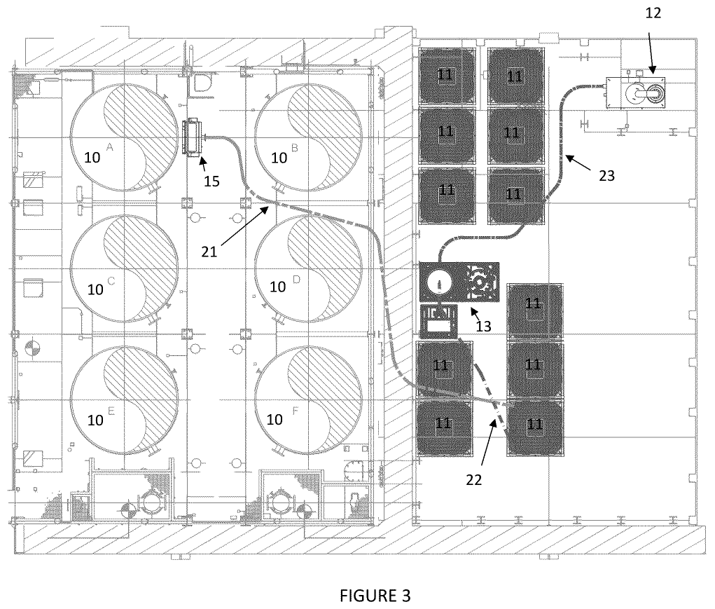

FIG. 3 illustrates a possible embodiment of the systems of FIGS. 1 and 2 in an offshore oil platform or rig. This embodiment is provided as an illustrative and non-limiting example.

Depending on the location of an oil well, the oil and/or gas produced may reach the surface mixed with a certain amount of H2S. The extraction of at least part of the H2S produced is necessary due to its high toxicity, which can be lethal to living beings in contact with it, and its corrosive nature, which can damage pipelines transporting natural gas from a platform to land. Thus, platforms are commonly equipped with reactors through which natural gas passes for H2S removal. Commonly used catalysts in this process include platinum and rhenium catalysts, nickel catalysts, and iron and cobalt oxides.

FIG. 3 illustrates part of a platform with six reactors 10 (A-F) containing saturated catalyst particles, eleven solid material tanks 11, a pump 12, an intermediate tank 13, and three transport lines 21, 22, 23. A connection box 15 is used at one end of transport line 21. Saturated catalyst particles are removed from reactor 10 (A) using the system of the invention and loaded into solid material tanks 11 until reactor 10 is free of saturated catalyst. The connection box 15 is then disconnected from reactor 10 (A) and connected to another reactor 10 (B-F) for the same unloading process. At some point, the solid material tank 11 will be filled with saturated catalyst. At that point, the other end of transport line 21 is disconnected from the inlet 71 of the full solid material tank 11 and connected to the inlet 71 of another empty solid material tank 11. Similarly, transport line 22 is disconnected from the outlet 72 of the full solid material tank 11 and connected to the outlet 72 of the other empty solid material tank 11.

The process is repeated until all six reactors 10 (A-F) are unloaded. At this point, the eleven solid material tanks 11 will be filled with saturated catalyst particles. A platform crane (not shown) lifts the eleven full solid material tanks 11 onto a support vessel, such as a tugboat, which transports the eleven full solid material tanks 11 to land. On land, the eleven full solid material tanks 11 are unloaded for proper processing and disposal of the saturated catalyst particles.

Also on land, empty solid material tanks 11 are filled with new unsaturated catalyst particles. The support vessel carries the solid material tanks 11 filled with unsaturated catalyst particles back to the platform, where they are hoisted back onto the platform.

The same system of the invention used to unload reactors 10 (A-F) is used to load these reactors. To do so, as explained, a pneumatic conveyor 81 is positioned below the intermediate tank 13. The inlet 71 and outlet 72 of the solid material tank 11 are closed, and the end of pneumatic line 22, which was previously connected to the outlet 72 of solid material tanks 11, is now connected to the lower outlet 61 of each solid material tank 11 filled with unsaturated catalyst particles for loading the reactors 10.

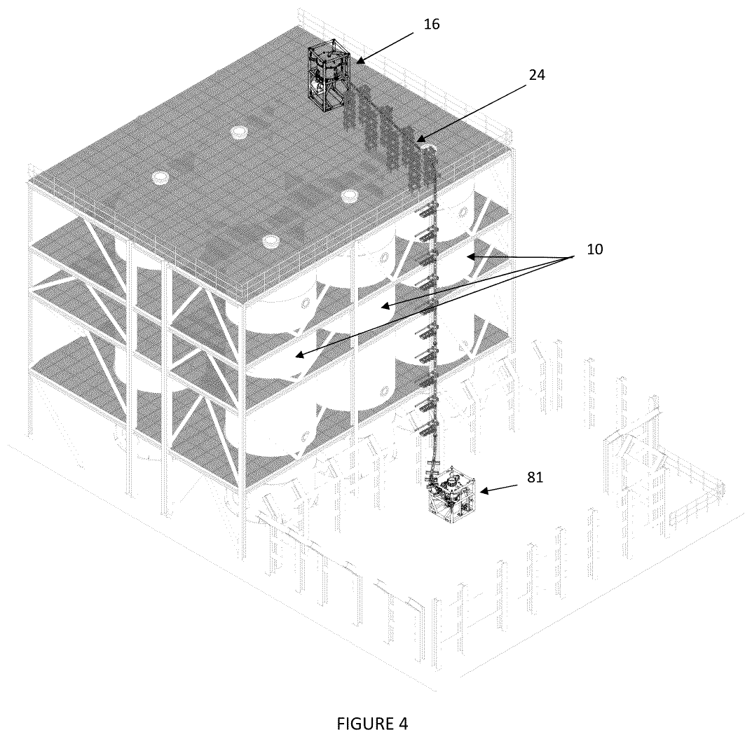

FIG. 4 shows the same part of the platform, emphasizing only the presence of the pneumatic conveyor 81, transport line 24, receiving box 16, and the six reactors 10 (A-F). Once a reactor 10 is sufficiently loaded with new unsaturated catalyst particles, the receiving box 16 is disconnected from that reactor and connected to another empty reactor 10 to be loaded with unsaturated catalyst particles. With all six reactors 10 (A-F) loaded with unsaturated catalyst particles, the solid material tanks 11 will be empty again. Thus, they will be ready to receive catalyst particles as they become saturated using the same loading and unloading system of the invention, ensuring the entire cycle is repeated.

Although six reactors are illustrated as an example, the loading and unloading process can be applied to any number of reactors. Similarly, the number of solid material tanks 11 may vary as needed or depending on the available space on the platform.

1. A system for loading and unloading solid material particles used for carrying out a physical, chemical, or biological process in one or more tanks, the system comprising:
an intermediate tank;
a pump; and
a pneumatic conveyor,
wherein the intermediate tank and the pump are fluidically connected,
wherein, for unloading a tank containing saturated or degraded solid material particles:
an empty or partially empty solid material tank is fluidically connected to the intermediate tank and to the tank containing saturated or degraded solid material particles; and
the pump is configured to generate a negative pressure in the intermediate tank, in the empty or partially empty solid material tank, and in the tank containing saturated or degraded solid material particles to move saturated or degraded solid material particles from inside the tank to the empty or partially empty solid material tank;
and wherein, for loading a tank:
a solid material tank containing unsaturated or undegraded solid material particles is fluidically connected to the intermediate tank;
the pump is configured to generate a negative pressure in the intermediate tank and in the solid material tank containing unsaturated or undegraded solid material particles to move unsaturated or undegraded solid material particles from the solid material tank to the intermediate tank;
the pneumatic conveyor is positioned below the intermediate tank, wherein the intermediate tank is configured to move the received unsaturated or undegraded solid material particles to the pneumatic conveyor; and
the pneumatic conveyor is fluidically connected to the tank to move the received unsaturated or undegraded solid material particles into the tank.

2. The system of claim 1, wherein the one or more tanks are reactors.

3. The system of claim 1, wherein the solid material is a catalyst, an adsorbent or both a catalyst and adsorbent.

4. The system of claim 1, wherein the one or more tanks, the solid material tank, the intermediate tank, and the pump are fluidically connected by means of transport lines, and the one or more tanks and the pneumatic conveyor are fluidically connected by means of transport line.

5. The system of claim 4, wherein the transport lines are rigid, flexible, or comprise both rigid and flexible sections.

6. The system of claim 1, wherein the solid material tank has a conical lower part and an outlet at the lower part.

7. The system of claim 1, wherein the intermediate tank has a conical lower part and an outlet at the lower part.

8. The system of claim 1, wherein the intermediate tank comprises a filtration means inside it to filter the flow of material arriving from the solid material tank.

9. The system of claim 1, wherein the solid material tank comprises a level sensor or a weight sensor.

10. The system of claim 1, wherein the intermediate tank comprises a level sensor or a weight sensor.

11. The system of claim 4, wherein the system comprises a connection box to connect the transport line connecting a tank to a solid material tank.

12. The system of claim 4, wherein the system comprises a receiving box at one end of the transport line connecting the pneumatic conveyor to a tank to direct the unsaturated or undegraded solid material particles into the tank.

13. A use of the system as defined in claim 1 for the loading and unloading of one or more tanks.

14. A method for loading or unloading solid material particles used for carrying out a physical, chemical, and/or biological process in one or more tanks, through a system as defined in claim 1, the method comprising the steps of:
for unloading a tank containing saturated or degraded solid material particles:
generating negative pressure in the intermediate tank, in the empty or partially empty solid material tank, and in the tank containing saturated or degraded solid material particles to move saturated or degraded solid material particles from inside the tank to the empty or partially empty solid material tank;
and, for loading a tank:
generating negative pressure in the intermediate tank and in the solid material tank containing unsaturated or undegraded solid material particles to move unsaturated or undegraded solid material particles from the solid material tank to the intermediate tank;
moving the unsaturated or undegraded solid material particles from the intermediate tank to the pneumatic conveyor; and
moving the unsaturated or undegraded solid material particles from the pneumatic conveyor to the tank.
